(19) United States
(12) Patent Application Publication
(10) Pub. No.: US 2024/0332742 A1
(43) Pub. Date: Oct. 3, 2024

(54) SECONDARY BATTERY AND ELECTRONIC APPARATUS

(71) Applicant: Ningde Amperex Technology Limited, Ningde (CN)

(72) Inventor: Kewen HU, Ningde (CN)

(73) Assignee: Ningde Amperex Technology Limited, Ningde (CN)

(21) Appl. No.: 18/621,506

(22) Filed: Mar. 29, 2024

(30) Foreign Application Priority Data
Mar. 31, 2023 (CN) 202310341138.7

(51) Int. Cl. H01M 50/486; H01M 10/0525; H01M 50/105

(52) U.S. Cl. CPC H01M 50/486; H01M 10/0525; H01M 50/105

(57) ABSTRACT

A secondary battery includes an electrode assembly and an adhesive member, the adhesive member being adhered to the electrode assembly; the adhesive member includes a stacked substrate layer and a first adhesive layer, the first adhesive layer including a binder and a first resin; the first resin includes a styrene-ethylene-butene-styrene block copolymer and a butyl rubber; and based on mass of the first adhesive layer, the binder has a mass percentage of 65% to 95%, and the first resin has a mass percentage of 5% to 35%. In the secondary battery provided in this application, the first adhesive layer includes the above substances, and the percentages thereof are controlled within the scope of this application, so that the first adhesive layer has a high hardness, which facilitates removal of bubbles between the adhesive member and the electrode assembly.

### CROSS-REFERENCE TO RELATED APPLICATION

The present application claims priority to Chinese Patent Application No. CN 202310341138.7 filed in the China National Intellectual Property Administration on Mar. 31, 2023, the entire content of which is hereby incorporated by reference.

### TECHNICAL FIELD

This application relates to the electrochemical field, specifically to a secondary battery and an electronic apparatus.

### BACKGROUND

In lithium-ion batteries, it is typically necessary to use adhesive paper for insulation and fixation of the lithium-ion battery. One commonly used adhesive paper is styrene-isoprene-styrene copolymer (SIS) adhesive paper. During the production process of lithium-ion batteries, SIS adhesive paper is adhered to an electrode assembly. However, there are flat-pressing bubbles between the SIS adhesive paper and the electrode assembly. These flat-pressing bubbles become apparent on the packaging bag after packaging, resulting in poor appearance of the lithium-ion battery and affecting the bonding effect between the adhesive member and the electrode assembly.

### SUMMARY

A purpose of this application is to provide a secondary battery and an electronic apparatus to reduce the number of flat-pressing bubbles of the secondary battery. Specific technical solutions are as follows:

A first aspect of this application provides a secondary battery. The secondary battery includes an electrode assembly and an adhesive member, the adhesive member being adhered to the electrode assembly; the adhesive member includes a stacked substrate layer and a first adhesive layer, the first adhesive layer including a binder and a first resin; the binder includes at least one of a polymethylmethacrylate, a polypropylene, a polyethylene, a polyamide, a styrene-butadiene rubber, a nitrile rubber, a male-butadiene rubber, an isoprene rubber, an ethylene-propylene rubber, or chloroprene rubber, the first resin including a styrene-ethylene-butene-styrene block copolymer and butyl rubber; and based on mass of the first adhesive layer, the binder has a mass percentage of 65% to 95% and the first resin has a mass percentage of 5% to 35%. In the secondary battery provided in this application, the first adhesive layer includes the above substances, and the percentages thereof are controlled within the scope of this application, so that the first adhesive layer has a high hardness at room temperature, which facilitates removal of bubbles between the adhesive member and the electrode assembly. As a result, the number of flat-pressing bubbles in the secondary battery can be reduced, addressing the problem of poor appearance of the secondary battery. Additionally, a low number of flat-pressing bubbles allows for a larger bonding area, a stronger bonding interface, and improved bonding strength between the adhesive member and the electrode assembly, helping to improve the safety performance of the secondary battery. Furthermore, the first adhesive layer exhibits good heat resistance, resistance to electrolyte swelling, chemical stability, and aging resistance, and there is a good bonding strength between the adhesive member and the electrode assembly, making the secondary battery have good cycling performance and safety performance. In this application, flat-pressing bubbles are bubbles generated between the adhesive member and the electrode assembly during binding of the adhesive member.

In some embodiments of this application, a mass ratio of styrene-ethylene-butene-styrene block copolymer to butyl rubber is 1:2 to 2:1. The mass ratio of the styrene-ethylene-butene-styrene block copolymer to the butyl rubber being controlled within the above range makes the first adhesive layer have a high softening point (100° C. to 120° C.), so as to improve hardness of the first adhesive layer at room temperature. This helps to remove bubbles between the adhesive member and the electrode assembly, thereby reducing the number of flat-pressing bubbles in the secondary battery, and addressing the problem of poor appearance of the secondary battery.

In some embodiments of this application, based on the mass of the first adhesive layer, the first resin has a mass percentage of 10% to 25%. The mass percentage of the first resin being controlled within the above range helps to reduce the number of flat-pressing bubbles of the secondary battery, addressing the problem of poor appearance of the secondary battery and making the secondary battery have good cycling performance and safety performance.

In some embodiments of this application, based on the mass of the first adhesive layer, the first resin has a mass percentage of 15% to 20%. This is advantageous to further reduce the number of flat-pressing bubbles of the secondary battery, addressing the problem of poor appearance of the secondary battery and making the secondary battery have good cycling performance and safety performance.

In some embodiments of this application, the first adhesive layer further includes a second resin, the second resin has a mass percentage of 2% to 5% based on the mass of the first adhesive layer, and the second resin includes at least one of a rosin resin, a terpene resin, a petroleum resin, or a gumarone resin. The second resin includes the above substances and the percentage of the second resin is controlled within the scope of this application, so that there is a good bonding strength between the adhesive member and the electrode assembly, making the secondary battery have a good cycling performance and a safety performance.

In some embodiments of this application, the first adhesive layer has a softening point of 100° C. to 120° C. It indicates that a higher softening point of the first adhesive layer enables the first adhesive layer to have a higher harness at room temperature and facilitates removal of bubbles between the adhesive member and the electrode assembly, thereby reducing the number of flat-pressing bubbles in the secondary battery and improving poor appearance of the secondary battery. Additionally, the first adhesive layer exhibits good heat resistance and resistance to electrolyte erosion, thereby facilitating improvement of a bonding strength between the adhesive member and the electrode assembly, and improving the safety performance of the secondary battery.

In some embodiments of this application, the first adhesive layer has a peel strength of 50 N/m to 400 N/m. The peel strength of the first adhesive layer is controlled within the above range, so that the possibility of the bonding interface between the adhesive member and the electrode assembly being damaged can be reduced, thereby improving the safety performance of the secondary battery.

In some embodiments of this application, the substrate layer includes at least one of polyethylene terephthalate, polyimide, or polypropylene. The above materials are selected, so that the substrate layer obtained provides good support and is resistant to electrolyte erosion.

In some embodiments of this application, the secondary battery further includes a housing, the adhesive member is provided between the electrode assembly and the housing, and the first adhesive layer is adhered to outer surface of the electrode assembly. With the features mentioned above, the secondary battery has a low number of bubbles between the adhesive member and the electrode assembly, which does not affect the appearance of the secondary battery. Furthermore, the bonding interface between the adhesive member and the electrode assembly has high strength, resulting in good safety performance.

In some embodiments of this application, the adhesive member further includes a second adhesive layer, the substrate layer including a first surface and a second surface arranged opposite to each other, the first adhesive layer is disposed on the first surface, the second adhesive layer is disposed on the second surface, and the second adhesive layer is adhered to inner surface of the housing; where the second adhesive layer includes a styrene-isoprene-styrene copolymer. Applying the adhesive member having the above features to the secondary battery can improve the safety performance of the secondary battery.

In some embodiments of this application, the housing is a packaging bag. Applying the adhesive member of this application to the secondary battery whose housing is a packaging bag can reduce the number of flat-pressing bubbles of the secondary battery, thereby addressing the problem of poor appearance of the secondary battery and making the secondary battery have good cycling performance and safety performance.

A second aspect of this application provides an electronic apparatus, where the electronic apparatus includes the secondary battery provided in the first aspect of this application. The secondary battery provided in the first aspect of this application has good cycling performance and safety performance, such that the electronic apparatus provided in the second aspect of this application has a long service life.

This application has the following beneficial effects:

This application provides a secondary battery and an electronic apparatus. The secondary battery includes an electrode assembly and an adhesive member, the adhesive member being adhered to the electrode assembly; the adhesive member includes a stacked substrate layer and a first adhesive layer, the first adhesive layer including a binder and a first resin; the binder includes at least one of a polymethylmethacrylate, a polypropylene, a polyethylene, a polyamide, a styrene-butadiene rubber, a nitrile rubber, a male-butadiene rubber, an isoprene rubber, an ethylene-propylene rubber, or chloroprene rubber, the first resin including a styrene-ethylene-butene-styrene block copolymer and butyl rubber; and based on mass of the first adhesive layer, the binder has a mass percentage of 65% to 95% and the first resin has a mass percentage of 5% to 35%. In the secondary battery provided in this application, the first adhesive layer includes the above substances, and the percentages thereof are controlled within the scope of this application, so that the first adhesive layer has a high hardness at room temperature, which facilitates removal of bubbles between the adhesive member and the electrode assembly. As a result, the number of flat-pressing bubbles in the secondary battery can be reduced, addressing the problem of poor appearance of the secondary battery. Additionally, a low number of flat-pressing bubbles allows for a larger bonding area, a stronger bonding interface, and improved bonding strength between the adhesive member and the electrode assembly, helping to improve the safety performance of the secondary battery. Furthermore, the first adhesive layer exhibits good heat resistance, resistance to electrolyte swelling, chemical stability, and aging resistance, and there is a good bonding strength between the adhesive member and the electrode assembly, making the secondary battery have good cycling performance and safety performance.

Certainly, it is not necessary for any product or method implementing this application to simultaneously achieve all the advantages described above.

### BRIEF DESCRIPTION OF DRAWINGS

To describe technical solutions in some embodiments of this application or in the prior art more clearly, the following briefly describes the accompanying drawings required for describing some embodiments or the prior art. Apparently, the accompanying drawings in the following descriptions show some embodiments of this application, and persons of ordinary skill in the art may still derive other drawings from these accompanying drawings.

FIG. 1 is a schematic diagram of a stacked structure of an adhesive member according to an embodiment of this application;

FIG. 2 is a schematic diagram of a stacked structure of an adhesive member according to another embodiment of this application; and

FIG. 3 is a schematic diagram of an adhesive member adhered to outer surface of an electrode assembly according to an embodiment of this application.

Reference signs are as follows: adhesive member 10, substrate layer 11, first adhesive layer 12, second adhesive layer 13, first surface 111, second surface 112, and electrode assembly 20.

### DETAILED DESCRIPTION

The following clearly and completely describes technical solutions in some embodiments of this application with reference to the accompanying drawings in some embodiments of this application. Apparently, the described embodiments are only some but not all of the embodiments of this application. Based on some embodiments of this application, all other embodiments obtained by persons of ordinary skill in the art based on this application shall fall within the protection scope of this application.

It should be noted that in the specific embodiments of this application, lithium-ion batteries are used as an example of secondary batteries to explain this application, but the secondary batteries of this application are not limited to lithium-ion batteries.

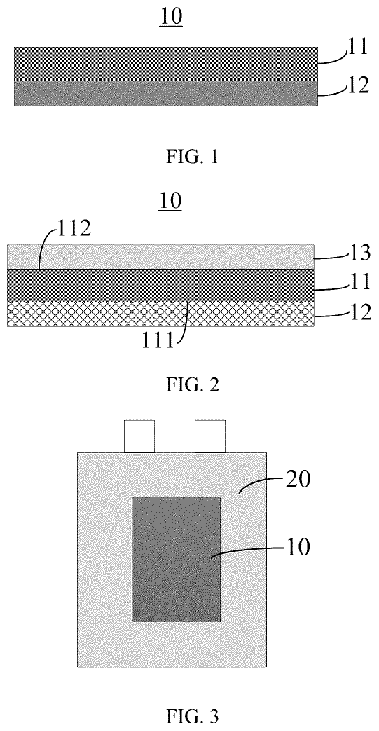

A first aspect of this application provides a secondary battery, where the secondary battery includes an electrode assembly and an adhesive member, and the adhesive member is adhered to the electrode assembly. As shown in FIG. 1, the adhesive member 10 includes a stacked substrate layer 11 and a first adhesive layer 12, the first adhesive layer 12 including a binder and a first resin; the binder includes at least one of a polymethylmethacrylate, a polypropylene, a polyethylene, a polyamide, a styrene-butadiene rubber, a nitrile rubber, a male-butadiene rubber, an isoprene rubber, an ethylene-propylene rubber, or chloroprene rubber, the first resin including a styrene-ethylene-butene-styrene block copolymer and butyl rubber; and based on mass of the first adhesive layer, the binder has a mass percentage of 65% to 95% and the first resin has a mass percentage of 5% to 35%, preferably 10% to 25%, further preferably 15% to 20%. For example, the mass percentage of the binder may be 65%, 70%, 75%, 78%, 80%, 83%, 85%, 88%, 90%, 95%, or a range formed by any two of these values, and the mass percentage of the first resin may be 5%, 7%, 10%, 15%, 17.5%, 20%, 25%, 30%, 35%, or a range formed by any two of these values.

Under a condition that the mass percentage of the first resin is excessively low, for example, less than 5%, the initial adhesive force of the first adhesive layer at room temperature is excessively large, which is unfavorable to the removal of bubbles between the adhesive member and the electrode assembly, and cannot address the problem of poor appearance of the secondary battery. Under a condition that the mass percentage of the first resin is excessively large, for example, greater than 35%, the initial adhesive force of the first adhesive layer at room temperature is excessively small, and the peel strength of the first adhesive layer is excessively small, which is not favorable to improving the bonding strength between the adhesive member and the electrode assembly. In the secondary battery provided in this application, the first adhesive layer includes the above substances, and the percentages thereof are controlled within the scope of this application, so that the first adhesive layer has a high hardness at room temperature, which facilitates removal of bubbles between the adhesive member and the electrode assembly. As a result, the number of flat-pressing bubbles in the secondary battery can be reduced, addressing the problem of poor appearance of the secondary battery. Additionally, a low number of flat-pressing bubbles allows for a larger bonding area, a stronger bonding interface, and improved bonding strength between the adhesive member and the electrode assembly, helping to improve the safety performance of the secondary battery. Furthermore, the first adhesive layer exhibits good heat resistance, resistance to electrolyte swelling, chemical stability, and aging resistance, and there is a good bonding strength between the adhesive member and the electrode assembly, making the secondary battery have good cycling performance and safety performance.

In some embodiments of this application, the mass ratio of the styrene-ethylene-butene-styrene block copolymer to the butyl rubber is 1:2 to 2:1, for example, the mass ratio of the styrene-ethylene-butene-styrene block copolymer to the butyl rubber may be 1:2, 1:1.5, 1:1, 1:0.6, 2:1, or a range formed by any two of these ratios. The mass ratio of the styrene-ethylene-butene-styrene block copolymer to the butyl rubber is controlled within the above range, enabling the first adhesive layer to have a high softening point (100° C. to 120° C.), thereby improving the hardness of the first adhesive layer at room temperature. Under a condition that the adhesive member is adhered to the surface of the electrode assembly, it is advantageous to remove bubbles between the adhesive member and the electrode assembly, thereby reducing the number of flat-pressing bubbles of the secondary battery and addressing the problem of poor appearance of the secondary battery.

In some embodiments of this application, the first adhesive layer includes a binder and a first resin, and further includes a second resin. Based on the mass of the first adhesive layer, the binder has a mass percentage of 65% to 90%, the first resin has a mass percentage of 5% to 30%, and the second resin has a mass percentage of 2% to 5%. For example, the mass percentage of the binder may be 65%, 70%, 75%, 78%, 80%, 83%, 85%, 88%, 90%, or a range formed by any two of these values, the mass percentage of the first resin may be 5%, 7%, 10%, 15%, 17.5%, 20%, 25%, 30%, or a range formed by any two of these values, and the mass percentage of the second resin may be 2%, 2.5%, 3%, 3.5%, 4%, 4.5%, 5%, or a range formed by any two of these values. The second resin includes at least one of a rosin resin, a terpene resin, a petroleum resin, or a gumarone resin, and the petroleum resin may include a C5 petroleum resin and a C9 petroleum resin. The first adhesive layer includes the binder, the first resin, and the second resin, the second resin includes the above substances, and the percentages thereof are controlled within the scope of this application. This is conducive to improving the bonding strength between the adhesive member and the electrode assembly, making the secondary battery have good cycling performance and safety performance.

In some embodiments of this application, the softening point of the first adhesive layer is 100° C. to 200° C., and the softening point of the first adhesive layer may be 100° C., 105° C., 110° C., 115° C., 120° C., or a range formed by any two of these values. It indicates that a higher softening point of the first adhesive layer enables the first adhesive layer to have a higher harness at room temperature and facilitates removal of bubbles between the adhesive member and the electrode assembly, thereby reducing the number of flat-pressing bubbles in the secondary battery and improving poor appearance of the secondary battery. Additionally, the first adhesive layer exhibits good heat resistance and resistance to electrolyte erosion, thereby facilitating improvement of a bonding strength between the adhesive member and the electrode assembly, and improving the safety performance of the secondary battery.

In some embodiments of this application, the first adhesive layer has a peel strength of 50 N/m to 400 N/m. The peel strength of the first adhesive layer may be 50 N/m, 70 N/m, 100 N/m, 150 N/m, 200 N/m, 250 N/m, 300 N/m, 350 N/m, 400 N/m, or a range formed by any two of these values. The peel strength of the first adhesive layer is controlled within the above range, so that the possibility of the bonding interface between the adhesive member and the electrode assembly being damaged can be reduced, thereby improving the safety performance of the secondary battery.

In some embodiments of this application, the substrate layer includes at least one of polyethylene terephthalate, polyimide, or polypropylene. The above materials are selected, so that the substrate layer obtained provides good support and is resistant to electrolyte erosion.

The substrate layer of this application may further include a colorant such as cobalt green, cobalt blue, Prussian blue, indigo, phthalocyanine blue, and the like so that the substrate has a color to be recognized by the inductively coupled device (CCD) during the production process for gluing positioning, gluing, leakage detection, and the like. This application does not particularly limit the percentage of the colorant in the substrate layer, and the colorant can be added according to the actual need, as long as the purpose of this application can be achieved.

In some embodiments of this application, the secondary battery further includes a housing, the adhesive member is provided between the electrode assembly and the housing, and the first adhesive layer is adhered to outer surface of the electrode assembly. The secondary battery having the above features has a low number of bubbles between the adhesive member and the electrode assembly, that is, a low number of flat-pressing bubbles, which does not affect the appearance of the secondary battery. In addition, the bonding interface between the adhesive member and the electrode assembly has a high strength, making the secondary battery have good safety performance.

In some embodiments of this application, as shown in FIG. 2, the adhesive member 10 further includes a second adhesive layer 13, the substrate layer 11 includes a first surface 111 and a second surface 112 arranged opposite to each other, the first adhesive layer 12 is disposed on the first surface 111, and the second adhesive layer 13 is disposed on the second surface 112, the second adhesive layer 13 is adhered to inner surface of the housing; and the second adhesive layer includes a styrene-isoprene-styrene copolymer (SIS). The secondary battery of this application includes the adhesive member, and in the preparation process of the secondary battery, as shown in FIG. 3, the adhesive member 10 is affixed to the electrode assembly 20 through the first adhesive layer 12. Then the electrode assembly 20 is put into a packaging bag and subject to activation treatment (such as hot pressing) to enable the second adhesive layer to bond to inner surface of the housing, such that the adhesive member bonds the electrode assembly and the housing, fixing the electrode assembly. This reduces the risk of top-sealing opening, leakage, and damage in special scenarios such as dropping, rolling, and impact of the secondary battery. Therefore, applying the adhesive member with the aforementioned features to the secondary battery can improve the safety performance of the secondary battery. The application does not particularly limit the hot pressing. For example, the activation treatment can be realized by hot pressing during the formation process, with a hot pressing temperature of 80° C. to 100° C. and a hot pressing pressure of 1 MPa to 2 MPa.

The second adhesive layer of this application may further include a functional resin, an antioxidant, and an additive, the functional resin may include, but is not limited to, at least one of ethylene-ethylene acetate copolymer, polyurethane elastomer (TPU), polyurethane acrylate, polyisobutylene, or polybutadiene; the additive may include, but is not limited to, at least one of titanium dioxide, talcum powder, silica, or calcium carbonate; and the antioxidant may include, but is not limited to, at least one of diphenylamine, phosphite triester, or dioctadecyl thiodipropionate. This application does not particularly limit the percentage of the functional resin, the antioxidant, and the additive, as long as the purpose of this application can be realized. For example, based on the mass of the second adhesive layer, the functional resin may have a mass percentage of 5% to 25%, the antioxidant has a mass percentage of 1% to 5%, the additive has a mass percentage of 1% to 5%, and the styrene-isoprene-styrene copolymer has a mass percentage of 70% to 95%. This application does not particularly limit the weight-average molecular weight of the styrene-isoprene-styrene copolymer and the functional resin, which can be selected according to the actual need, as long as the purpose of this application can be realized. For example, the weight-average molecular weight of the styrene-isoprene-styrene copolymer may be 50,000 to 200,000, and the weight-average molecular weight of the functional resin may be 20,000 to 500,000.

The second adhesive layer of this application can also be designed with patterns, dividing the second adhesive layer into N regions spaced apart, where N≥4. There is a gap between adjacent regions of the second adhesive layer to separate the two regions. The gap is used for venting. The application does not particularly limit the size of these gaps, as long as the purpose of venting can be realized. The application does not particularly limit the sum of areas of the N regions of the second adhesive layer, as long as venting is ensured without affecting the bonding performance of the second adhesive layer.

In some embodiments of this application, the housing is a packaging bag. For example, the packaging bag may be an aluminum-plastic film packaging bag. Applying the adhesive member of this application to the secondary battery whose housing is a packaging bag can reduce the number of flat-pressing bubbles of the secondary battery, thereby addressing the problem of poor appearance of the secondary battery and making the secondary battery have good safety performance.

This application has no special limitations on the method of preparing the adhesive member, as long as the purpose of this application can be realized. For example, the adhesive member of this application can be prepared by the following method: material of the second adhesive layer is hot-melted at 60° C. to 80° C., and then applied on the second surface of the substrate layer, and dried to form the second adhesive layer; and then the binder, the first resin, and the second resin are mixed uniformly, hot-melted at 100° C. to 120° C., and then applied on the first surface of the substrate layer, and dried to form the first adhesive layer, so as to obtain the adhesive member.

This application does not particularly limit the weight-average molecular weight of the binder and the first resin, which can be selected according to the actual needs, as long as the purpose of this application can be realized. For example, the weight-average molecular weight of the binder may be 10,000 to 250,000, and the weight-average molecular weight of the first resin may be 100,000 to 300,000. This application does not particularly limit the thickness of the substrate layer, the first adhesive layer, and the second adhesive layer, as long as the purpose of this application can be realized. For example, the thickness of the substrate layer is 4 μm to 30 μm, the thickness of the first adhesive layer is 2 μm to 10 μm, and the thickness of the second adhesive layer is 2 μm to 20 μm.

The secondary battery of this application includes an electrode assembly, an electrolyte, a housing, and an adhesive member. The electrode assembly and the electrolyte are accommodated in the housing. This application does not particularly limit the structure of the electrode assembly, as long as the purpose of this application can be realized. For example, the structure of the electrode assembly has a stacked structure or a wound structure. The electrode assembly includes a positive electrode plate, a negative electrode plate, and a separator, and the separator is provided between the positive electrode plate and the negative electrode plate. The separator is used to separate the positive electrode plate and the negative electrode plate to prevent an internal short circuit in the secondary battery, allowing free movement of electrolyte ions without affecting the electrochemical charging and discharging processes.

This application does not particularly limit the positive electrode plate, as long as the purpose of this application can be realized. For example, the positive electrode plate includes a positive electrode current collector and a positive electrode active material layer provided on at least one surface of the positive electrode current collector. This application does not particularly limit the positive electrode current collector, as long as the purpose of this application can be achieved. For example, the positive electrode current collector may include an aluminum foil, an aluminum alloy foil, or the like. The positive electrode active material layer of this application includes a positive electrode active material. A type of the positive electrode active material is not particularly limited in this application, as long as the purpose of this application can be achieved. For example, the positive electrode active material may include at least one of lithium nickel cobalt manganese oxide (NCM811, NCM622, NCM523, and NCM111), lithium nickel cobalt aluminate, lithium iron phosphate, lithium manganese-rich material, lithium cobalt oxide (LiCoO₂), lithium manganate, lithium manganese ferro-manganese phosphate, or lithium titanate, and the like. In this application, thicknesses of the positive electrode current collector and the positive electrode active material layer are not particularly limited, as long as the purpose of this application can be achieved. For example, the positive electrode current collector has a thickness of 5 μm to 20 μm, and preferably 6 μm to 18 μm. A one-sided positive electrode active material layer has a thickness of 30 μm to 150 μm. In this application, the positive electrode active material layer may be disposed on one surface of the positive electrode current collector in a thickness direction or may be disposed on two surfaces of the positive electrode current collector. It should be noted that the “surface” herein may be an entire region or a partial region of the positive electrode current collector. This is not particularly limited in this application, as long as the purpose of this application can be achieved. The positive electrode active material layer of this application may further include a conductive agent and a binder. The aforementioned conductive agent and binder are not particularly limited, as long as the purpose of this application can be realized. For example, the conductive agent may include at least one of conductive carbon black (Super P), carbon nanotubes (CNTs), carbon nanofibers, scaled graphite, carbon dots, or graphene. The binder may include at least one of polyacryl alcohol, sodium polyacrylate, potassium polyacrylate, lithium polyacrylate, polyimide, polyamide imide, styrene-butadiene rubber (SBR), polyvinyl alcohol (PVA), polyvinylidene fluoride (PVDF), polytetrafluoroethylene (PTFE), polyvinyl butyral (PVB), aqueous acrylic resins, carboxymethyl cellulose (CMC), sodium carboxymethyl cellulose (CMC-Na), and the like.

This application does not particularly limit the negative electrode plate, as long as the purpose of this application can be realized. For example, the negative electrode plate includes a negative electrode current collector and a negative electrode active material layer provided on at least one surface of the negative electrode current collector. The negative electrode current collector is not particularly limited in this application, as long as the purpose of this application can be achieved. For example, the negative electrode current collector may include a copper foil, a copper alloy foil, a nickel foil, a stainless steel foil, a titanium foil, a nickel foam, a copper foam, or the like. The negative electrode active material layer of this application includes a negative electrode active material. A type of the negative electrode active material is not particularly limited in this application, as long as the purpose of this application can be achieved. For example, the negative electrode active material may include at least one of natural graphite, artificial graphite, intermediate-phase micro carbon spheres (MCMB), hard carbon, soft carbon, silicon, silicon-carbon complexes, SiOₓ(0<x≤2), Li—Sn alloys, Li—Sn—O alloys, Sn, SnO, SnO₂, spinel-structured lithium titanate Li₄Ti₅O₁₂, Li—Al alloy, or lithium metal. This application does not particularly limit the thickness of the negative electrode current collector and the negative electrode active material layer, as long as the purpose of this application can be realized. For example, the negative electrode current collector has a thickness of 4 μm to 20 μm, and the negative electrode active material layer has a thickness of 30 μm to 150 μm. In this application, the negative electrode active material layer may be disposed on one surface in a thickness direction of the negative electrode current collector or may be disposed on two surfaces in the thickness direction of the negative electrode current collector. It should be noted that the “surface” herein may be the entire region or a portion of the negative electrode current collector, and there is no special restriction in this application as long as the purpose of this application can be realized. Optionally, the negative electrode active material layer may further include a conductive agent and a binder. This application does not particularly limit the types of the conductive agent and the binder in the negative electrode active material layer, as long as the purpose of this application can be realized. For example, the negative electrode active material layer of this application may include the foregoing conductive agent and the binder. This application does not particularly limit the mass ratio of the negative electrode active material, the conductive agent, and the binder in the negative electrode active material layer, as long as the purpose of this application can be realized.

This application does not particularly limit the separator, as long as the purpose of this application can be realized. For example, material of the separator may include, but is not limited to, at least one of polyethylene (PE), polypropylene (PP), polytetrafluoroethylene-based polyolefin (PO), polyester (such as polyethylene terephthalate (PET)), cellulose, polyimide (PI), polyamide (PA), spandex, or aramid, or the like. The type of separator may include, but is not limited to, at least one of a woven film, a non-woven film (nonwoven), a microporous film, a composite film, a laminated film, a spunlace film, or the like. The separator of this application may have a porous structure. The porous layer is provided on at least one surface of the separator, the porous layer includes inorganic particles and a binder, and the inorganic particles may include at least one of alumina oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide or barium sulfate. The binder may include at least one of polyvinylidene fluoride, a copolymer of vinylidene fluoride-hexafluoropropylene, polyamide, polyacrylonitrile, polyacrylate ester, polyacrylic acid, polyacrylate, sodium carboxymethyl cellulose, polyvinylpyrrolidone, polyvinyl ether, polymethylmethacrylate, polytetrafluoroethylene, or polyhexafluoropropylene. This application does not particularly limit the size of pores of the porous structure, as long as the purpose of this application can be realized. For example, the size of the pores may be 0.01 μm to 2 μm. This application does not particularly limit the thickness of the separator, as long as the purpose of this application can be realized. For example, the thickness can be 4 μm to 500 μm.

In this application, the electrolyte includes a lithium salt and a non-aqueous solvent. In some embodiments of this application, the lithium salt may include at least one of LiPF₆, LiBF₄, LiClO₄, LiB(C₆H₅)₄, LiCH₃SO₃, LiCF₃SO₃, LIN(SO₂CF₃)₂, LiC(SO₂CF₃)₃, LiSiF₆, lithium bisoxalate borate (LiBOB), or lithium difluoroborate. This application does not particularly limit the concentration of the lithium salt in the electrolyte, as long as the purpose of this application can be achieved. This application does not particularly limit the non-aqueous solvent, as long as the purpose of this application can be achieved. For example, the non-aqueous solvent may include but is not limited to at least one of carbonate compound, carboxylate compound, ether compound, or another organic solvent. The carbonate compound may include but is not limited to at least one of a linear carbonate compound, a cyclic carbonate compound, or a fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethylene propyl carbonate (EPC), or methyl ethyl carbonate (MEC). The cyclic carbonate may include but is not limited to at least one of ethylene carbonate (EC), propylene carbonate (PC), butylene carbonate (BC), or vinyl ethylene carbonate (VEC). The fluorocarbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of dibutyl ether, tetraethylene glycol dimethyl ether, diglyme, 1,2-dimethoxyethane, 1,2-diethoxyethane, 1-ethoxy-1-methoxyethane, 2-methyltetrahydrofuran, or tetrahydrofuran. The another organic solvent may include but is not limited to at least one of dimethyl sulfoxide, 1,2-dioxolane, sulfolane, methyl-sulfolane, 1,3-dimethyl-2-imidazolidinone, N-methyl-2-pyrrolidone, dimethylformamide, acetonitrile, trimethyl phosphate, triethyl phosphate, or trioctyl phosphate.

This application does not particularly limit the type of the secondary battery, and the secondary battery may include any apparatus in which an electrochemical reaction occurs. For example, the secondary battery may include but is not limited to a lithium metal secondary battery, a lithium-ion battery, a sodium-ion battery, a lithium polymer secondary battery, or a lithium-ion polymer secondary battery. This application does not particularly limit the shape of the secondary battery, as long as the purpose of this application can be achieved.

A preparation process of the secondary battery is well known to a person skilled in the art, and is not particularly limited in this application. For example, the preparation process may include but is not limited to the following steps: a positive electrode plate, a separator, and a negative electrode plate are stacked in sequence and go through operations such as winding and folding as needed to obtain an electrode assembly with a wound structure, the electrode assembly is put into a packaging bag, and the packaging bag is injected with an electrolyte and sealed to obtain a secondary battery; or a positive electrode plate, a separator, and a negative electrode plate are stacked in sequence, four corners of the entire stacked structure are fixed with tapes to obtain an electrode assembly with a stacked structure, the electrode assembly is put into a packaging bag, and the packaging bag is injected with an electrolyte and sealed to obtain a secondary battery. In addition, an overcurrent prevention element, a guide plate, and the like may also be placed in the packaging bag as needed, thereby preventing pressure increase, and overcharge and overdischarge inside the secondary battery.

A second aspect of this application provides an electronic apparatus, where the electronic apparatus includes the secondary battery provided in the first aspect of this application. The secondary battery provided in the first aspect of this application has good cycling performance and safety performance, such that the electronic apparatus provided in the second aspect of this application has a long service life.

The electronic apparatus in this application is not particularly limited, and may be any known electronic apparatus used in the prior art. For example, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, or a large household battery.

### EXAMPLES

The following describes the embodiments of this application more specifically by using examples and comparative examples. Various tests and evaluations were performed in the following methods. In addition, unless otherwise specified, “part” and “%” are based on weight.

### Test Methods and Devices

### Composition Test of the First Adhesive Layer:

The lithium-ion battery was disassembled to take out the first adhesive layer, and then components and the percentage of each component in the first adhesive layer are tested using Fourier-transform infrared spectroscopy (FTIR) and the pyrolysis-gas chromatography-mass spectrometry (PY-GCMS).

### Softening Point Test:

The softening point of the first adhesive layer was tested using a differential scanning calorimeter (DSC). The specific process was as follows: the lithium-ion battery was disassembled to take out the first adhesive layer and then the first adhesive layer was completely dried in a vacuum oven at 60° C. The sample mass required for the test was 1 g. The sample was heated from room temperature to 200° C. at an elevated temperature rate of 10° C./min and held at the temperature for 5 min. It was then cooled to 0° C. and held at the temperature for 5 min. The DSC curve was analyzed to obtain the softening point of the first adhesive layer.

### Peel Strength Test:

The peel strength of the first adhesive layer was used to measure the bonding strength between the adhesive member and the electrode assembly. A higher the peel strength of the first adhesive layer leads to a higher bonding strength between the adhesive member and the electrode assembly. The peel strength of the first adhesive layer was tested by using a high-speed rail tensile machine according to GB/T 2792-2014 “Test Method for Peel Strength of Adhesive Tape”. The testing process was as follows: the lithium-ion battery was disassembled to take out the adhesive member along with the part of the electrode assembly and the part of the packaging bag part that are bonded to the adhesive member, as a whole, and electrolyte on the surface was wiped with dust-free paper. Then the adhesive member was cut into strip-shaped samples of 20 mm×60 mm. Along a length direction of the sample, a side of the sample with the electrode assembly was adhered to a steel plate using double-sided tap (Nitto 5000 NS), with an adhesion length of not less than 40 mm (in a case that the sample length is insufficient, a tape of equal width can be used to be bonded on an end of the test sample under tension, to extend the total length of the test sample, facilitating the clamping of the sample by the fixture). The steel plate was fixed in a corresponding position of the high-speed tensile tester, the other end of the test sample which is not adhered to the electrode assembly was pulled up, and the test sample was put into the jaws for clamping, with the angle between the pulled part of the sample and the steel plate being 180° in space, and the jaws pulled the sample at a speed of 5±0.2 mm/s. Finally, the average value of the pulling force in the smooth region was recorded as the peel strength of the first adhesive layer, with the unit of N/m.

### Statistics of the Number of Flat-Pressing Bubbles:

The adhesive members of each example and the comparable example were cut into 50 mm×30 mm, and then the adhesive members were adhered to the electrode assembly, and the electrode assembly with the adhesive member was photographed for recording, and the number of bubbles with a maximum size larger than 5 mm was counted, and was recorded as the number of flat-pressing bubbles. Since the shape of the bubbles can be irregular, the aforementioned maximum size is the length between the two points farthest apart in the same bubble range in a straight line.

### Cycling Performance Test:

In the test environment of 23±2° C., the lithium-ion battery of each example and comparative example was charged at a constant current of 2.9C to 4.2 V, and charged at the constant voltage to a current of 2.67C; charged at a constant current of 2.67C to 4.25 V, and charged at the constant voltage to a current of 2C; charged at the constant current of 2C to 4.3 V, charged at the constant voltage to a current of 1.5C; charged at the constant current of 1.5C to 4.38 V, charged at the constant voltage to a current of 1.2C; charged at the constant current 1.2C to 4.45 V, and charged at the constant voltage to a current of 0.21C. After standing for 5 minutes, the lithium-ion battery was discharged at the constant current of 1.5C to 3.5 V; and then discharged at a constant current of 0.7C to 3.0 V. The initial discharge capacity C₀ was recorded. This process was repeated for 1200 cycles and then the discharge capacity C₁ after 1200 cycles turns was recorded, and the capacity retention rate of the lithium-ion battery was calculated: Capacity retention rate=C₁/C₀×100%.

### Rolling Test:

In the test environment of 25° C., the lithium-ion battery of each example and comparative example was left to stand for 60 min, and the voltage of the lithium-ion battery was tested and recorded before the rolling test; the lithium-ion battery was loaded into a clamping, and the lithium-ion battery was freely dropped by using a roller device in a test environment of 20±5° C. from a position 1 m above the ground for 500 cycles (2 drops per cycle) at a rotational speed of 5 revolutions/min, and the voltage of the lithium-ion battery was measured after the test, with noting that the appearance of the lithium-ion battery was checked and photographed before and after the test. The rolling test was considered passed in a case that there is no fire, smoke, or liquid leakage, and the voltage drop was less than 50 m V.

### Drop Test:

The lithium-ion battery of each example and the comparative example was left to stand for 60 min in an environment of 25° C. for pretreatment, and then the voltage of the lithium-ion battery was tested and recorded before the drop test; the lithium-ion battery was loaded into a clamping, and the lithium-ion battery was dropped freely from the position 1.5 m above the ground using a drop device in the following order: head-tail-head right corner-tail right corner-head left corner-tail left corner (angle: 45±15°). The dropping was repeated for 6 rounds. After the drop test, the voltage of the lithium-ion battery was measured and recorded, with noting that the appearance of the lithium-ion battery needs to be checked and photographed before and after the test. The drop test was considered passed in a case that there is no fire, smoke, or liquid leakage, and the voltage drop was less than 30 mV.

### Example 1

### <Preparation of Positive Electrode Plate>

A positive electrode active material LiCoO₂, a conductive agent conductive carbon black, and a binder polyvinylidene fluoride (PVDF) were mixed at a weight ratio of 97.5:1:1.5, with N-methylpyrrolidone (NMP) added as solvent, so as to prepare a slurry with a solid content of 73.5 wt %, where the slurry was stirred uniformly. The slurry was uniformly applied on a positive electrode current collector aluminum foil with a thickness of 9 μm and dried at 90° C. so as to obtain a positive electrode plate with a coating thickness of 120 μm. After the foregoing steps were completed, single surface coating of the positive electrode plate was completed. Then, the foregoing steps were repeated on the other surface of the positive electrode plate so as to obtain a positive electrode plate with two surfaces coated with the positive electrode active material. After the coating was completed, followed by cold pressing, cutting, and splitting, and the positive electrode plate was then dried under vacuum at 85° C. for 4 hours to obtain the positive electrode plate with dimensions of 74 mm×867 mm.

### <Preparation of Negative Electrode Plate>

A negative electrode active material graphite power, a conductive agent conductive carbon black (Super P), and a binder styrene-butadiene rubber (SBR) were mixed at a mass ratio of 96:1.5:2.5, added with deionized water as a solvent, and prepared into a slurry with a solid content of 70 wt %, and the slurry was stirred uniformly. The slurry is uniformly applied on one surface of a negative electrode current collector copper foil with a thickness of 8 μm, and dried at 110° C., to obtain a negative electrode plate coated with a negative electrode active material on one side with a coating thickness of 130 μm. Upon completion of the above steps, the negative electrode plate is coated on one side. Afterwards, the above steps are repeated on the other surface of the negative electrode plate to obtain a negative electrode plate coated with the negative electrode active material on both sides. After the coating was completed, followed by cold pressing, cutting, and splitting, and the negative electrode plate was then dried under vacuum at 120° C. for 12 hours to obtain the negative electrode plate with dimensions of 76.6 mm×875 mm.

### <Preparation of Separator>

PVDF and alumina ceramic were mixed according to the mass ratio of 8:2. Then, deionized water was added as a solvent to prepare a slurry with a solid content of 25 wt %, which was stirred uniformly. The slurry was uniformly applied on one surface of a 5 μm-thick polyethylene porous polymer film (supplied by Celgard) and dried, and then the slurry was uniformly applied on the other surface of the polyethylene porous polymer film, to obtain a separator coated with a 2 μm alumina ceramic layer on both sides.

### <Preparation of Electrolyte>

In a dry argon atmosphere, organic solvents vinyl carbonate, methyl ethyl carbonate, and diethyl carbonate were mixed in a mass ratio of 30:50:20 to obtain an organic solution, and then the lithium salt LiPF₆ was added to the organic solvent, dissolved and mixed uniformly, to obtain an electrolyte with a lithium salt concentration of 1.15 mol/L.

### <Preparation of Adhesive Member>

The materials of the second adhesive layer, styrene-isoprene-styrene copolymer (SIS, with a weight-average molecular weight of 100,000), functional resin polyurethane elastomer (TPU, with a weight-average molecular weight of 80,000), additive titanium dioxide, and antioxidant diphenylamine were mixed uniformly according to the mass ratio of 80:15:2.5:2.5, heated to 120° C. to melt, applied on a second surface of an 8 μm substrate layer of polyethylene terephthalate film (PET), and then dried at 120° C. to form a second adhesive layer with a thickness of 8 μm. Then the binder polymethylmethacrylate (PMMA), the first resin styrene-ethylene-butene-styrene block copolymer (SEBS) and butyl rubber (IIR), and the second resin terpene resin (with a weight-average molecular weight of 120,000) were mixed uniformly and heated to 150° C. to melt, and then applied on a first surface of a substrate layer PET, dried at 80° C. to form a first adhesive layer with a thickness of 4 μm, so as to obtain an adhesive member including the second adhesive layer, the substrate layer, and the first adhesive layer stacked in sequence. Based on the mass of the first adhesive layer, the binder PMMA has a mass percentage of 75%, the first resin has a mass percentage of 20%, where the mass ratio of SEBS to IIR is 1:1, and the second resin terpene resin a mass percentage of 5%.

### <Preparation of Lithium-Ion Battery>

The prepared positive electrode plate, separator, and negative electrode plate were stacked in sequence, so that the separator was sandwiched between the positive electrode plate and the negative electrode plate for separation. Then winding was performed to obtain an electrode assembly of a wound structure, and tab welding was performed. The prepared adhesive member was adhered to outer surface of the electrode assembly through the first adhesive layer. Then, the electrode assembly was placed in an aluminum-plastic film packaging bag and subjected to processes such as top-side sealing, vacuum drying, electrolyte injection, formation (85° C., 1.1 MPa, 3.5 V), capacity measurement, and degassing to obtain a lithium-ion battery.

### Example 2 to Example 13

Except for adjusting the preparation parameters according to Table 1, the remaining steps are the same as in example 1.

### Comparative Example 1

Except for the absence of the first resin and the second resin in the first adhesive layer, the remaining steps are the same as in example 1.

### Comparative Examples 2 and 3

Except for adjusting the preparation parameters according to Table 1, the remaining steps are the same as in example 1.

The relevant preparation parameters and performance tests of the examples and comparative examples are shown in table 1.

TABLE 1

| | | | | | | Softening | Peel | | | | |
|---|---|---|---|---|---|---|---|---|---|---|---|
| | | Mass | | Mass | | point of | strength | | | | |
| | Mass | percentage | Mass | percentage | | first | of first | Number | Capacity | Rolling | Drop |
| | percentage | of first | ratio of | of second | Type of | adhesive | adhesive | of flat- | retention | test | test |
| | of binder | resin | SEBS | resin | second | layer | layer | pressing | rate | pass | pass |
| | (%) | (%) | to IIR | (%) | resin | (° C.) | (N/m) | bubbles | (%) | rate | rate |
| Example 1 | 90 | 5 | 1:1 | 5 | Terpene | 102.5 | 394 | 6 | 88.3 | 17/20 | 19/20 |
| | | | | | resin | | | | | | |
| Example 2 | 85 | 10 | 1:1 | 5 | Terpene | 105.3 | 342 | 3 | 88.0 | 19/20 | 20/20 |
| | | | | | resin | | | | | | |
| Example 3 | 80 | 15 | 1:1 | 5 | Terpene | 109.2 | 296 | 0 | 88.7 | 20/20 | 20/20 |
| | | | | | resin | | | | | | |
| Example 4 | 75 | 20 | 1:1 | 5 | Terpene | 113.7 | 237 | 0 | 88.4 | 20/20 | 20/20 |
| | | | | | resin | | | | | | |
| Example 5 | 70 | 25 | 1:1 | 5 | Terpene | 117.1 | 159 | 0 | 88.1 | 18/20 | 20/20 |
| | | | | | resin | | | | | | |
| Example 6 | 65 | 30 | 1:1 | 5 | Terpene | 119.8 | 68 | 0 | 87.9 | 17/20 | 18/20 |
| | | | | | resin | | | | | | |
| Example 7 | 90 | 8 | 1:1 | 2 | Terpene | 103.8 | 363 | 7 | 88.2 | 19/20 | 19/20 |
| | | | | | resin | | | | | | |
| Example 8 | 75 | 20 | 1:2 | 5 | Terpene | 113.5 | 245 | 0 | 88.6 | 20/20 | 20/20 |
| | | | | | resin | | | | | | |
| Example 9 | 75 | 20 | 2:1 | 5 | Terpene | 113.8 | 232 | 0 | 88.4 | 20/20 | 20/20 |
| | | | | | resin | | | | | | |
| Example 10 | 75 | 20 | 1:4 | 5 | Terpene | 113.2 | 251 | 2 | 88.1 | 20/20 | 19/20 |
| | | | | | resin | | | | | | |
| Example 11 | 75 | 20 | 4:1 | 5 | Terpene | 113.4 | 236 | 3 | 88.3 | 19/20 | 19/20 |
| | | | | | resin | | | | | | |
| Example 12 | 75 | 20 | 1:1 | 5 | C5 | 113.6 | 220 | 0 | 88.5 | 20/20 | 20/20 |
| | | | | | petroleum | | | | | | |
| | | | | | resin | | | | | | |
| Example 13 | 80 | 20 | 1:1 | 0 | / | 110.1 | 289 | 0 | 87.2 | 18/20 | 19/20 |
| Comparative | 100 | 0 | / | 0 | / | 82.4 | 434 | 17 | 87.5 | 16/20 | 17/20 |
| example 1 | | | | | | | | | | | |
| Comparative | 92 | 3 | 1:1 | 5 | Terpene | 98.5 | 417 | 12 | 87.3 | 13/20 | 15/20 |
| example 2 | | | | | resin | | | | | | |
| Comparative | 55 | 40 | 1:1 | 5 | Terpene | 123.6 | 25 | 0 | 87.1 | 11/20 | 14/20 |
| example 3 | | | | | resin | | | | | | |

Note:
“/” in Table 1 indicates that the parameter is not present; the molecular weight of the above C5 petroleum resin is 1500.

Referring to Table 1, it can be seen from example 1 to example 7 and comparative example 1 that in a case that the first adhesive layer includes the binder and the first resin, and the mass percentages of the binder and the first resin are controlled within the scope of this application, the first adhesive layer has a larger peel strength, the number of flat-pressing bubbles is less, and the lithium-ion battery has a higher capacity retention rate, and a higher pass rate in the rolling test and the drop test, indicating that the lithium-ion battery has better cycling performance and safety performance.

It can be seen from example 1 to example 7 and comparative example 2 that in a case that the first resin has an excessively small mass percentage, the first adhesive layer has a larger peel strength, but the number of flat-pressing bubbles is larger, indicating that the problem of poor appearance of the secondary battery cannot be addressed in a case that the first resin has an excessively small mass percentage. It can be seen from example 1 to example 7 and comparative example 3, in a case that the first resin has an excessively large mass percentage, the first adhesive layer has an excessively small peel strength, resulting in a low bonding strength between the adhesive member and the electrode assembly and a low pass rate in the rolling test and the drop test of the lithium-ion battery, indicating that it is difficult to balance the appearance and safety performance of the lithium-ion battery in a case that the first resin has an excessively large mass percentage. Thereby, the mass percentage of the first resin is controlled within the scope of this application, so that the first adhesive layer has greater peel strength, the number of flat-pressing bubbles is less, and the lithium-ion batteries have a higher capacity retention rate, and a higher pass rate in the rolling test and the drop test, indicating that the lithium-ion battery has better cycling performance and safety performance.

The mass ratio of SEBS to IIR affects the cycling performance and safety performance of lithium-ion batteries. It can be seen from example 4 and example 8 to example 11, that in a case that the mass ratio of SEBS to IIR is within the scope of this application, the first adhesive layer has a larger peel strength, the number of flat-pressing bubbles is less, the lithium-ion batteries have a higher capacity retention rate, and a higher pass rate in the rolling test and the drop test, indicating that the lithium-ion batteries have better cycling performance and safety performance.

The softening point of the first adhesive layer usually affects cycling performance and safety performance of the lithium-ion battery. It can be seen from example 1 to example 13 that in a case that the softening point of the first adhesive layer is controlled within the scope of this application, the first adhesive layer has a higher peel strength while the number of flat-pressing bubbles is less, and the lithium-ion batteries have a higher capacity retention rate, and a higher pass rate in the rolling test and the drop test, indicating that the lithium-ion battery has good cycling performance and safety performance.

The type of the second resin affects the cycling performance and safety performance of the lithium-ion battery. It can be seen from example 4 and example 12 that in a case that the second resin within the scope of this application is selected, the first adhesive layer has a larger peel strength, the number of flat-pressing bubbles is less, and the lithium-ion batteries have a higher capacity retention rate, and a higher pass rate in the rolling test and the drop test, indicating that the lithium-ion battery has good cycling performance and safety performance.

The mass percentage of the second resin affects the cycling performance and safety performance of the lithium-ion battery. It can be seen from example 1, example 7, and example 13 that in a case that the mass percentage of the second resin is controlled within the scope of this application, the first adhesive layer has a larger peel strength, and the number of flat-pressing bubbles is less, and the lithium-ion batteries have a higher capacity retention rate, and a higher pass rate in the rolling test and the drop test, indicating that the lithium-ion battery has good cycling performance and safety performance.

It should be noted that relational terms such as “first” and “second” are only used to distinguish one entity or operation from another entity or operation, and do not necessarily require or imply that there is any such actual relationship or order between these entities or operations. Terms “comprise”, “include”, or any other variations thereof are intended to cover non-exclusive inclusions, such that a process, method, or article including a series of elements not only includes these elements, but also includes other elements which are not expressly listed, or further includes elements which are inherent to such process, method, or article.

The embodiments in this specification are described in a related manner. For a part that is the same or similar between the embodiments, reference may be made between the embodiments. Each embodiment focuses on differences from other embodiments.

The foregoing descriptions are merely preferred examples of this application, and are not intended to limit the protection scope of this application. Any modifications, equivalent substitutions, improvements, or the like made within the spirit and principles of this application are included in the scope of protection of this application.

What is claimed is:

1. A secondary battery, comprising an electrode assembly and an adhesive member, the adhesive member being adhered to the electrode assembly; the adhesive member comprises a substrate layer and a first adhesive layer stacked together, the first adhesive layer comprising a binder and a first resin; the binder comprises at least one of a polymethylmethacrylate, a polypropylene, a polyethylene, a polyamide, a styrene-butadiene rubber, a nitrile rubber, a male-butadiene rubber, an isoprene rubber, an ethylene-propylene rubber, or chloroprene rubber, the first resin comprising a styrene-ethylene-butene-styrene block copolymer and butyl rubber; and based on a mass of the first adhesive layer, the binder has a mass percentage of 65% to 95% and the first resin has a mass percentage of 5% to 35%.

2. The secondary battery according to claim 1, wherein a mass ratio of styrene-ethylene-butene-styrene block copolymer to butyl rubber is 1:2 to 2:1.

3. The secondary battery according to claim 1, wherein the first resin has the mass percentage of 10% to 25% based on the mass of the first adhesive layer.

4. The secondary battery according to claim 1, wherein the first resin has the mass percentage of 15% to 20% based on the mass of the first adhesive layer.

5. The secondary battery according to claim 1, wherein the first adhesive layer further comprises a second resin, the second resin has a mass percentage of 2% to 5% based on the mass of the first adhesive layer; and the second resin comprises at least one of a rosin resin, a terpene resin, a petroleum resin, or a gumarone resin.

6. The secondary battery according to claim 1, wherein the first adhesive layer has a softening point of 100° C. to 120° C.

7. The secondary battery according to claim 1, wherein the first adhesive layer has a peel strength of 50 N/m to 400 N/m.

8. The secondary battery according to claim 1, wherein the substrate layer comprises at least one of polyethylene terephthalate, polyimide, or polypropylene.

9. The secondary battery according to claim 1, further comprising a housing, the adhesive member is provided between the electrode assembly and the housing, and the first adhesive layer is adhered to an outer surface of the electrode assembly.

10. The secondary battery according to claim 9, wherein the adhesive member further comprises a second adhesive layer, the substrate layer comprises a first surface and a second surface arranged opposite to each other, the first adhesive layer is disposed on the first surface, the second adhesive layer is disposed on the second surface, and the second adhesive layer is adhered to an inner surface of the housing; wherein
the second adhesive layer comprises a styrene-isoprene-styrene copolymer.

11. The secondary battery according to claim 9, wherein the housing is a packaging bag.

12. An electronic apparatus, wherein the electronic apparatus comprises the secondary battery;
the adhesive member being adhered to the electrode assembly; the adhesive member comprises a substrate layer and a first adhesive layer stacked together, the first adhesive layer comprising a binder and a first resin; the binder comprises at least one of a polymethylmethacrylate, a polypropylene, a polyethylene, a polyamide, a styrene-butadiene rubber, a nitrile rubber, a male-butadiene rubber, an isoprene rubber, an ethylene-propylene rubber, or chloroprene rubber, the first resin comprising a styrene-ethylene-butene-styrene block copolymer and butyl rubber; and based on a mass of the first adhesive layer, the binder has a mass percentage of 65% to 95% and the first resin has a mass percentage of 5% to 35%.

13. The electronic apparatus according to claim 12, wherein a mass ratio of styrene-ethylene-butene-styrene block copolymer to butyl rubber is 1:2 to 2:1.

14. The electronic apparatus according to claim 12, wherein the first resin has the mass percentage of 10% to 25% based on the mass of the first adhesive layer.

15. The electronic apparatus according to claim 12, wherein the first resin has the mass percentage of 15% to 20% based on the mass of the first adhesive layer.

16. The electronic apparatus according to claim 12, wherein the first adhesive layer further comprises a second resin, the second resin has a mass percentage of 2% to 5% based on the mass of the first adhesive layer; and the second resin comprises at least one of a rosin resin, a terpene resin, a petroleum resin, or a gumarone resin.

17. The electronic apparatus according to claim 12, wherein the first adhesive layer has a softening point of 100° C. to 120° C.

18. The electronic apparatus according to claim 12, wherein the first adhesive layer has a peel strength of 50 N/m to 400 N/m.

19. The electronic apparatus according to claim 12, wherein the substrate layer comprises at least one of polyethylene terephthalate, polyimide, or polypropylene.

20. The electronic apparatus according to claim 12, further comprising a housing, the adhesive member is provided between the electrode assembly and the housing, and the first adhesive layer is adhered to an outer surface of the electrode assembly.
